(19) United States
(12) Patent Application Publication
(10) Pub. No.: US 2016/0055535 A1
(43) Pub. Date: Feb. 25, 2016

(54) DIGITAL SIGN NETWORK

(71) Applicant: INGENUITY SUN MEDIA LLC, Randolph, NJ (US)

(72) Inventors: Nelson Martinez, Wantage, NJ (US); John T. Morgan, Jupiter, FL (US)

(21) Appl. No.: 14/776,973

(22) PCT Filed: Mar. 14, 2014
(86) PCT No.: PCT/US14/27890

§ 371 Date: Sep. 15, 2015

Related U.S. Application Data
(60) Provisional application No. 61/787,512, filed on Mar. 15, 2013.

(51) Int. Cl. G06Q 30/02

(52) U.S. Cl. CPC G06Q 30/0261; G06Q 30/0267; G06Q 30/0269

(57) ABSTRACT

A marketing system is disclosed which includes a digital sign network which includes clusters of two or more signs are connected to a common digital network wherein each cluster is deployed in a single locale selected to serve a common marketing objective or to focus on a selected target group and wherein the signs in each cluster are fed the same digital content in real time in combination with coordinated advertisements accessible on mobile communication devices. For example, a cluster of signs may be located around a sports field and display the same content regarding future sports events at the field. In one embodiment of the invention, the signs are solar powered with a back-up from the utility power grid.

### CROSS REFERENCE TO RELATED APPLICATIONS

This application claims priority to and the benefit of U.S. Provisional Patent Application No. 61/787,512, filed Mar. 15, 2013, hereby incorporated by reference.

### BACKGROUND OF THE INVENTION

1. Field of the Invention

The present invention relates to a marketing system which includes a digital sign network which includes clusters of two or more signs are connected to a common digital network wherein each cluster is deployed in a single locale selected to serve a common marketing objective or to focus on a selected target group with a specific demographic and wherein the signs in each cluster are fed the same digital content in real time in combination with coordinated advertisements accessible on mobile communication devices.

2. Description of the Prior Art

Various systems employing digital sign networks are known in the art. An example of such a system is disclosed in US Patent Application No. US 2008/01400493 A1, hereby incorporated by reference. Such a system includes a plurality of digital signs connected in a common electrical network which display digital content on a time shared basis. Although such digital signs display digital content on a real-time basis, the '493 does not discuss the criteria for locating the signs. Normally, the location of such signs is selected on the basis of visibility. In other words, each digital sign is located in a place where the most people are expected to see it. As such, the digital signs do not focus on a specific target group nor marketing objective. Thus, there is a need for a marketing system which is focused on a specific target group or marketing objective.

### SUMMARY OF THE INVENTION

Briefly, the invention relates to a marketing system which includes a digital sign network which includes clusters of two or more signs are connected to a common digital network wherein each cluster is deployed in a single locale selected to serve a common marketing objective or to focus on a selected target group and wherein the signs in each cluster are fed the same digital content in real time in combination with coordinated advertisements accessible on mobile communication devices. For example, a cluster of signs may be located around a sports field and display the same content regarding future sports events at the field. In one embodiment of the invention, the signs are solar powered with a back-up from the utility power grid.

### DESCRIPTION OF THE DRAWING

These and other advantages of the present invention will be readily understood with reference to the following specification and attached drawing wherein:

FIG. 1 is a diagram illustrating a parking mall and parking lot with no billboards or digital signs.

FIG. 2 is a diagram of various strip malls which identifies an exemplary target demographic group; namely teens.

FIG. 3 is a diagram of casinos which identifies another demographic group; namely casino goers.

FIG. 4 is an aerial view of a shopping mall illustrating using various point of display (POD) digital signs illustrating a target consumer group.

FIG. 5 is a simplified electrical diagram illustrating the power flow of a solar powered digital sign with a utility backup.

FIG. 6 is a diagram illustrating an exemplary network of digital signs.

FIG. 7 is similar to FIG. 6 but illustrating multiple networks.

FIG. 8 is an exemplary diagram illustrating consumer interaction with the digital sign network.

FIG. 9 is an exemplary diagram illustrating how consumers can be connected to marketing material across multiple platforms.

FIG. 10 is a software flow diagram for the system.

### DETAILED DESCRIPTION

The present invention relates to a marketing system which includes a digital sign network which includes clusters of two or more signs are connected to a common digital network wherein each cluster is deployed in a single locale selected to serve a common marketing objective or to focus on a selected target group and wherein the signs in each cluster are fed the same digital content in real time in combination with coordinated advertisements accessible on mobile communication devices. For example, a cluster of signs may be located around a sports field and display the same content regarding future sports events at the field. In one embodiment of the invention, the signs are solar powered with a back-up from the utility power grid.

The marketing system is designed as a dual revenue generator to serve three key constituents:
Advertisers
Investors-mainly in the renewable energy sectors
Retail property owners

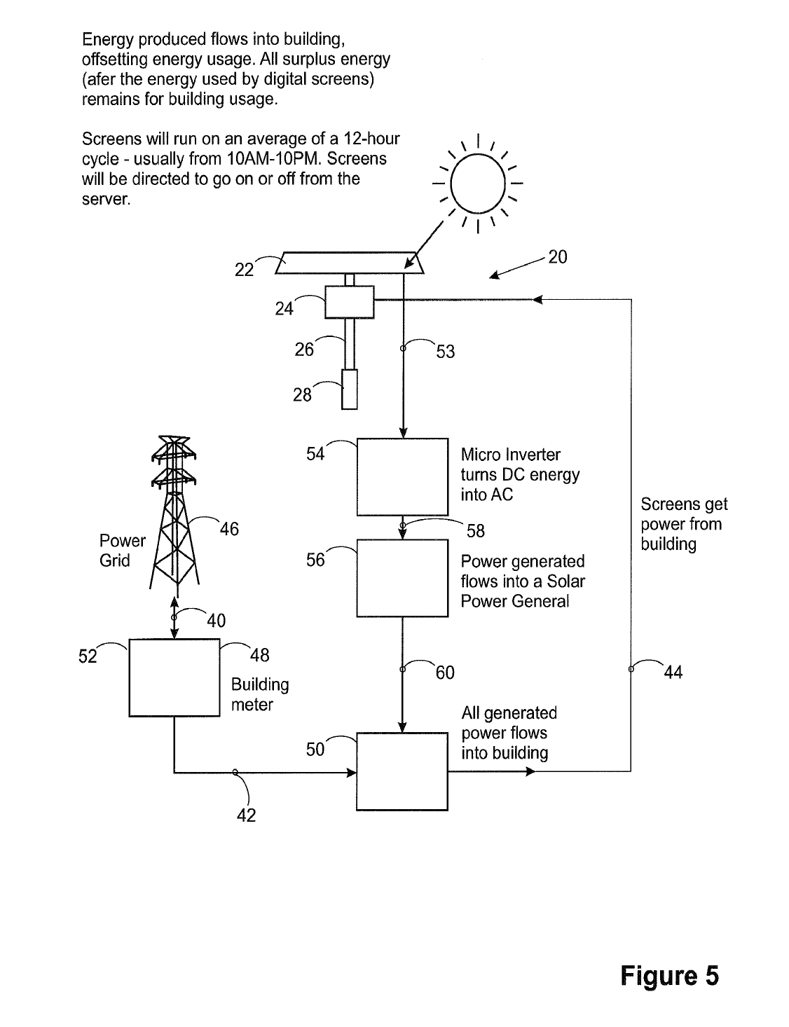

The marketing system comprises a network of sun power-assisted, digital signs or media trees (Fig.5) installed, for example, on the parking lots of shopping malls and other consumer aggregator locations. The network disclosed herein will drive local and national advertising through LED or LCD screens mounted on media trees (FIG. 5). The systems include a digital sign network, which includes a number of digital signs connected to a common network. Digital sign networks are known in the art, for example, as illustrated in US Patent Application Publication No. US 2008/0140493 A1, hereby incorporated by reference.

Specifically, the systems deploys at least one cluster of digital signs in a single locale with a common marketing objective and feeds the same content to all of the digital signs in the cluster in real time, with the added benefit of expanding the messaging beyond the local cluster to other clusters at locations which aggregate a similar consumer, as well as delivering the messaging on a Shoppers Network (web based). Thus an exemplary network may be made up, for example, of single parking lot networks, networked to other parking lot networks, and then networked together on line. All of the digital signage on the Media Trees are solar power-assisted.

### Benefits to Advertisers

Network-The digital network is designed to aggregate like-consumers across multiple properties. The system has been designed so as to enable seamless digital networking, across not only multiple media trees, but also across multiple media tree equipped properties.

This approach allows for maximum flexibility in reach, and easy interconnectivity of systems as more installations come on line. Thus maximizing reach and more importantly revenue potential.

The Ingenuity Sun Media Network of Sun Media Trees is expanded beyond the parking lot by virtue of being connected to the web-based Ingenuity Shoppers Network.

### Benefits to Retail Property Owners

Property, revenue-generation enhancement-Just as crucial; networking around consumer segments allows for properties, which on their own, might not offer advertisers an appealing enough reach story, to suddenly become powerful marketing tools.

The identification of viable advertising space at the retailer's parking lots, and the deployment of digital networks on those properties provide the property owners with previously unavailable revenues via ad share dollars or through lease/rent payments to them from ISM.

### Benefits to Investors

The Power Purchase Agreement (PPA) investment marketplace has experienced a contraction due to the low ROI of solar energy projects. This low ROI is caused by a combination of market forces, mainly the degraded value of state and federal incentives (SRECS at a state level), and Federal Tax credits.

The system model seeks to add a line of revenue to existing and new PPAs (PPAs as funding mechanisms for solar energy products such as solar farms, or large roof top and parking lot arrays). This new ad driven revenue (even at low levels) is a key ingredient to the financial models of PPAs, and will help lift the ROI of existing and new PPAs to levels that are acceptable and inviting to investors. Thus ISM is creating a variation of a PPA, the MPPA (Media Power Purchase Agreement).

### Duality is Key to the Concept

Ingenuity Sun Media Systems are made possible by the fact that they qualify as Energy generating, Solar energy producing products, which provide the necessary requirements to qualify for all available Solar Energy Generation state and local incentives, while generating ad revenue, thus making existing and new Sun Energy projects better investments (with healthier ROls). Solar Power federal/state incentives+Ad Revenue=Improved ROI performance of Solar Energy Projects.

### ISM Network Concept Implementation Process

1. Identification of underused, real state at consumer aggregator spots at and around areas where large, and clearly defined groups of consumers which can be aggregated into like consumer target groups, such as parking lots at malls, stadia, universities, highways rest stops, etc.

2. Identify a consumer along a specific demo and give advertisers the required impressions number (impressions numbers are media industry measurements used to measure how many people see an ad and for how long they view the advertising presented to them at one time). Target consumer selection is done by identifying a consumer segment that is valuable to advertisers- it can be around an activity, or around consumer specific demo/data.

3. Aggregate the selected grouping with a specific number of impressions in mind. Compile a large list of likely venues, and seek not to sign up every property but a certain basis number, which is driven by the number of impressions across the select consumer group. Thus delivering an impactful consumer grouping, which will deliver advertisers the focused targeting they expect, with quantifiable reach and numbers of impressions, and which assures a healthy ROI.

4. Identify locations, which share consumer group selected. After ISM aggregates and creates consumer groups across a specific consumer segment, then we seek out the properties, which deliver the quantities of the target consumer group needed to fulfill our reach goal. Once those properties are identified at specified geographic areas, we approach the property owners. Data is quantifiable and from trusted sources. This targeting, and verification of consumer data is based on a number of research platforms such as Arbitron, Nielsen, mall owner data, consumer counts, US census data, and a number of other accepted measuring methods.

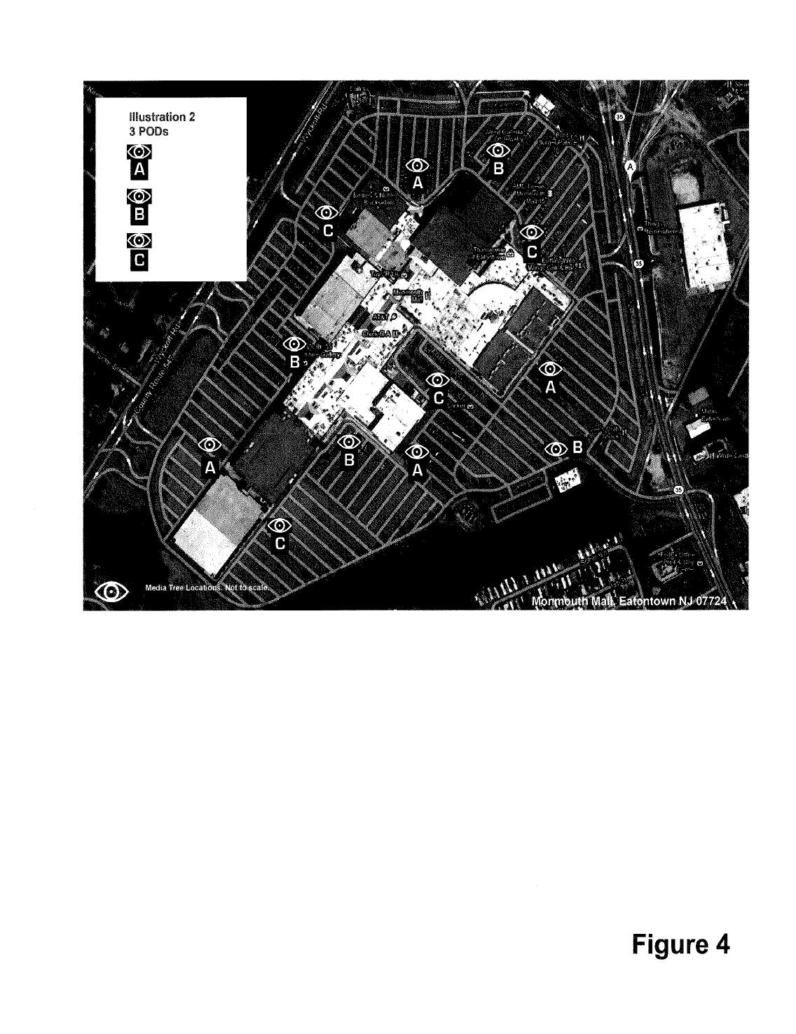

5. Deployment- Point Of Display (POD) System (FIG. 4). Once a target grouping is created then installation of Media Tree begins (Systems can be a combination of one or all of the Ingenuity products, Media Trees, Digital Screens without Media Trees, or Digital Screens on Solar Car-Ports, all of which can be part of larger ground level, or roof mounted solar arrays.) Whatever the system configuration, the various Screens will be networked in one locations using a POD system approach. The Point Of Display (POD) System FIG. 4) is designed to offer advertisers a high degree of coverage of the targeted consumers at a specific location. In the sample sited on illustration 2, the system is designed to have 3 PODS. Each POD will deliver the same advertising across the network. Thus ensuring that the consumer has access to the advertising no matter which point of entry they use to go into the mall. Advertising frequency will be variable per market. Each POD displays its own grouping of advertising messages.

### Media Tree

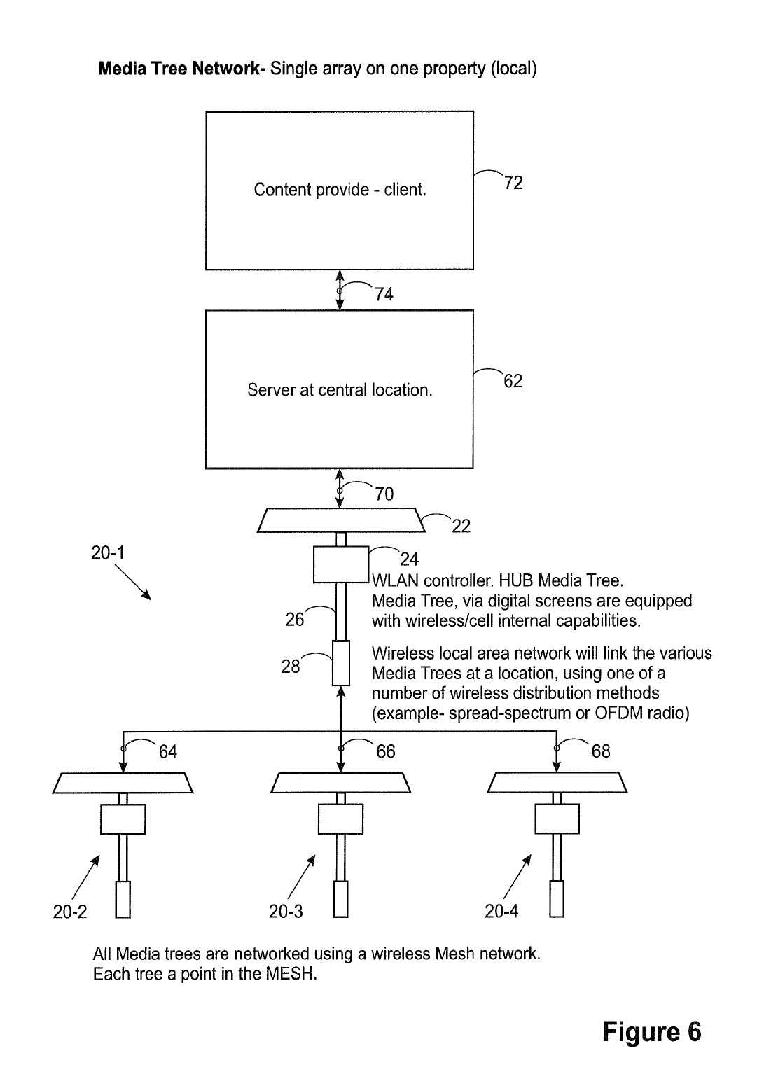

Exemplary simplified block diagrams for the digital signs, also referred to as media trees, in accordance with the invention, are illustrated in FIGS. 5-8. These media trees are primarily used in outdoor applications. Physical drawings for an exemplary media tree is illustrated in FIGS. 11a-11c. FIG. 5 relates to a power flow diagram while FIGS. 6-8 relate to control diagrams.

### Physical Details

Referring first to FIG. 5, each media tree, generally identified with the reference numeral 20, includes one or more solar panels 22, for example, Sun Module Model No. SW 245 mono black/version 2.0 and 2.5 frame, as manufactured by Solar World. One or more solar panels 22 are mounted on a common frame and form an assembly, as described below.

The media tree 20 also includes a display, screen or media panel 24, for example, a dynamic digital display, implemented as an electronic digital display, such as LED, LCD, plasma or other electronic display. The displays may be 3′ by 5′. LED type displays may be 10 MM, 12 MM and 12 MM, for example, as manufactured by Daktronics or Watchfire Media.

In one embodiment, the display may be configured as dynamic digital display 24 may include a wireless transceiver that enables the display 24 to receive and display selected streaming digital content from a remote digital media player over a wireless communication link, such as a radio link using various modulation techniques, such as spread spectrum or orthogonal frequency division multiplex modulation techniques. The dynamic digital display 24 may also have a cellular phone link.

The electronic digital display mounted on a post 24, secured on one end to a pedestal 28. The display 24 may be 3′ high and 5′ wide, other sizes and aspect ratios are also suitable. The display 24 is mounted to the post 26.

As shown best in FIGS. 11a-11c, an exemplary array of two (2) by three (3) solar panels 22 are shown. The solar panels 22 are an exemplary 3′ by 5′ in size. These solar panels 22 may be mounted to a frame 30, illustrated in FIG. 11c. As shown, the solar panels 22 may be secured to the frame 30 which, in turn, are secured to a cross bar assembly 32 that includes a sleeve 34 that enables the solar panels 22 to be secured to the post 26 forming a solar panel assembly. As shown in FIG. 11a, the frame 30 may be tilted, for example 20° with respect to a horizontal plane.

The post 28 may be formed from a hollow tube and secured at one end by a reinforced concrete pedestal, for example, 24″ in diameter and a minimum of 4′ long. A plurality of hook bolts, for example, four (4), are disposed within the concrete to form lugs (not shown). extending upwardly from a top surface of the concrete. These lugs allow a base 36 of post to be secured to the pedestal 28 in a conventional manner.

A conduit 38 is disposed in the pedestal 28 for receiving underground control and power wiring.(not shown). One end of the conduit 38 is in communication with the hollow post 26. An opposing end of the conduit 28 extends outwardly from the bottom of the pedestal 28. External power and control cables are fed into each media tree 20, as will be discussed in more detail below.

The dimensions shown in FIGS. 11a-11c are merely exemplary. However, as shown, the display 24 may be mounted a minimum of 7 feet from the ground. The solar panels 22 may be mounted between 10′ or 10′6″ to 15′ or 15′6″ from the ground.

The frame 30 may be rigidly mounted or moveably mounted with respect to the post 26. More particularly, the frame 30 may be movable manually. Alternatively, the frame 30 may be configured as a solar tracker which automatically varies the position of the solar panels 22 as a function of the position of the sun relative to the solar panels 22. Such solar tracking devices are known in the art. Examples of such solar tracking devices are disclosed in U.S. Pat. Nos. 8,119.963; 8,188,414; and 8,203,110 as well as US Patent Application Publication Nos. US 2012/0180780 A1 and US 2012/.0216851 A1, all incorporated by reference.

### Electric Power Details

Referring to FIG. 5, an exemplary power circuit for each media tree 20 is illustrated. Power for each media panel 24 is provided by an external AC power source, as indicated by the links 40, 42 and 44. For example, as shown, the media panel 24 is fed from the utility power grid, identified by the reference numeral 46. The invention may take advantage of net energy metering which use well known smart meters that read in reverse. As such, the power grid 46 may be connected by way of a smart utility meter which reads the power provided to the media tree 20 by the power grid 46 and also reads the power provided by the solar panels 22 back to the power grid 46. Such smart utility meters are well known in the art.

Alternatively, the utility power from the power grid 46 can be kept separate from the power generated by the media tree 20. In such an application, the electric power from the utility power grid is fed into a junction box 50 by way of the link 40 to a utility power meter 52 which measures the utility power provided to the media tree 20. The utility power is applied to the junction box 50 by way of the link 42. The junction box 50 may include conventional circuitry which may include a voltage regulator to transform the power from the building meter 52 to a voltage appropriate for the media panel 24 in order to provide electric power to the media panel 24 by way of the link 44.

In this alternative embodiment, the power generated by the solar panels 22 may be isolated from the power provided by the utility power grid. More specifically, energy generated by the solar panels 22 is DC power. This DC power may be applied to an inverter 54 by way of the link 53. The inverter 54 converts the DC power from the solar panels 22 to AC power The inverter 54 may be a micro-inverter, for example, an EnPhase Model M215, micro-inverter. The AC power from the inverter 54 may be applied to a separate meter 56 by way of the link 58. Each media tree 20 may be rated at 1.5 kW DC, which is the converted into AC through the use of a micro-inverter. The meter 56 reads the power generated by the solar panels 22. This power is directed to the junction box 50 by way of the link 60 and is phase synchronized with the utility power grid 46 fed back to the utility power grid 46 by way of the links 42 and 40.

Various links are referred to in the power circuit, described above. These links include the links 40, 42, 44, 53, 58 and 60. These links refer to physical power cables. These power cables as well as the are carried in the conduit 38 (FIG. 11b) and the hollow post 26

### Control Details

FIGS. 6-8 illustrate various configurations of the media trees 20, illustrated in FIG. 5. As mentioned above, each of the media panels 24 may be dynamic digital devices that include a transceiver. Such a configuration allows multiple media trees 20-1 20-2; 20-3 and 20-4 to be networked together under the control of a personal computer (not shown).programmed as a LAN or WLAN controller, which are well known in the art.

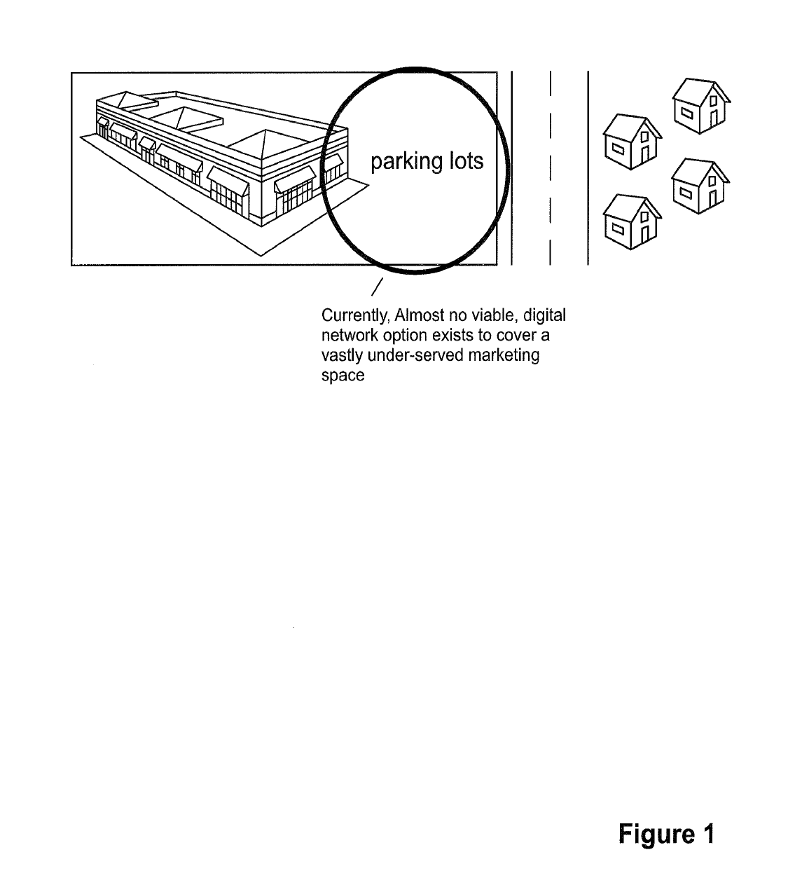

Various networking configurations are contemplated. FIG. 6 illustrates an exemplary mesh network configuration. Such a configuration is contemplated for use on a single venue, for example, as illustrated in FIG. 1. As shown in FIG. 6, each of the media trees 20-1; 20-2; 20-3 and 20-4 is a node or a point in the mesh, connected to a LAN or WLAN controller, shown as a server 62. In this case, the server 62 includes a digital media player and can stream the same digital content to all of the media trees 20-1; 20-2; 20-3 and 20-4 at the same time. The media trees 20-1; 20-2; 20-3 and 20-4 are connected to network by way of the wireless communication links 64, 66, 68 and 70. As mentioned above, these links 64, 66, 68 and 70 can be wireless communication link, such as, radio links using various modulation techniques, such as spread spectrum or orthogonal frequency division multiplex modulation techniques, or a cellular phone link.

The server 62 may be centrally located with respect to the media trees 64, 66, 68 and 70. Digital content to be streamed to the media trees 20-1; 20-2; 20-3 and 20-4 may be stored on a local or remote storage device 72. Remote storage devices 72 may be connected to the server by way of a wireless link 74 or by way of the Internet.

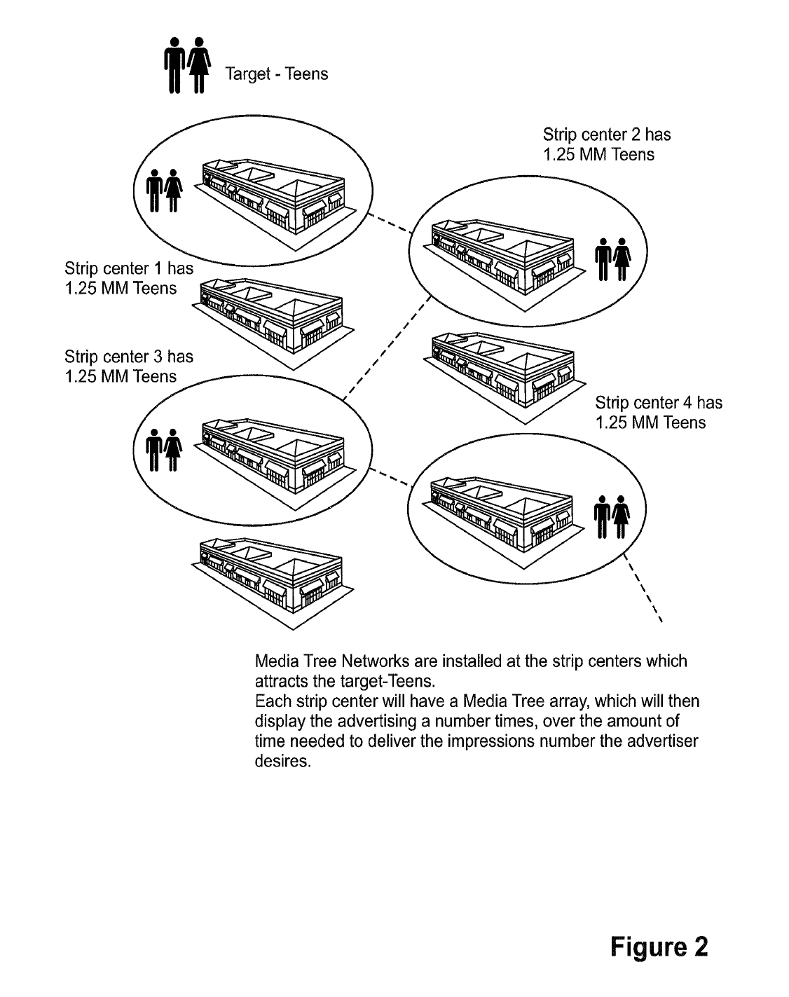

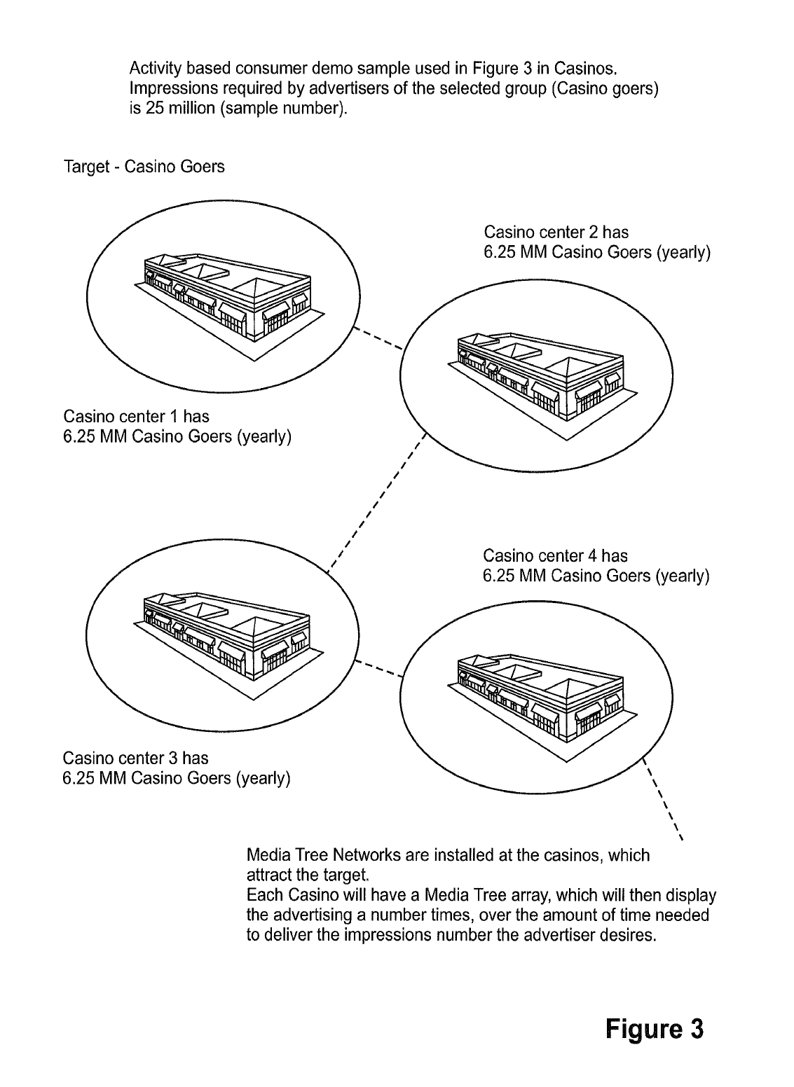

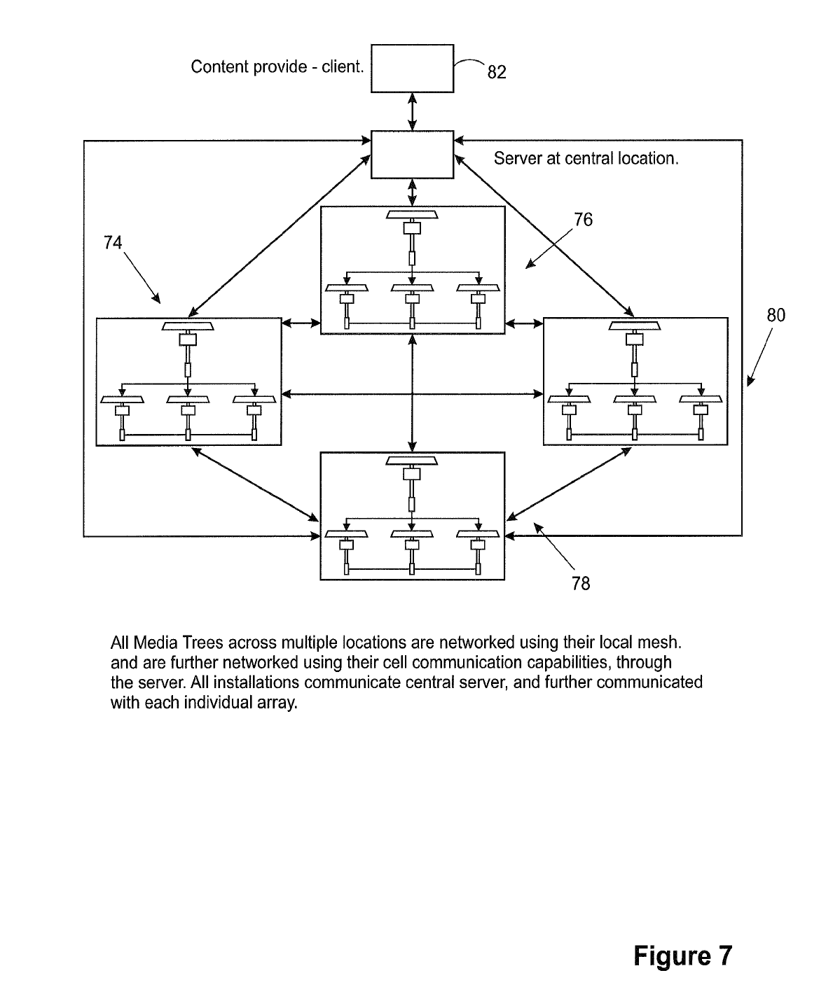

FIG. 7 illustrates an alternate network configuration of the media trees 20, In this configuration a number of local mesh networks, 74, 76, 78 and 80 are networked together and connected to a server 80, which, in turn, receives content from a database 82. Such a configuration may be used for multiple venues or locations, for example, as shown in FIGS. 2-4. The same digital content may be displayed in the examples illustrated in FIGS. 2 and 3 because of the common marketing objective. FIG. 4 illustrates an exemplary installation in Monmouth Mall in Eatontown, N.J. in which media trees 20 may be grouped to accomplish different marketing objectives. For example, three exemplary groups are shown and identified as A, B and C. As shown, Each group A, B and C is spread out in the mall.

### Sun Media Tree and Consumer Interaction

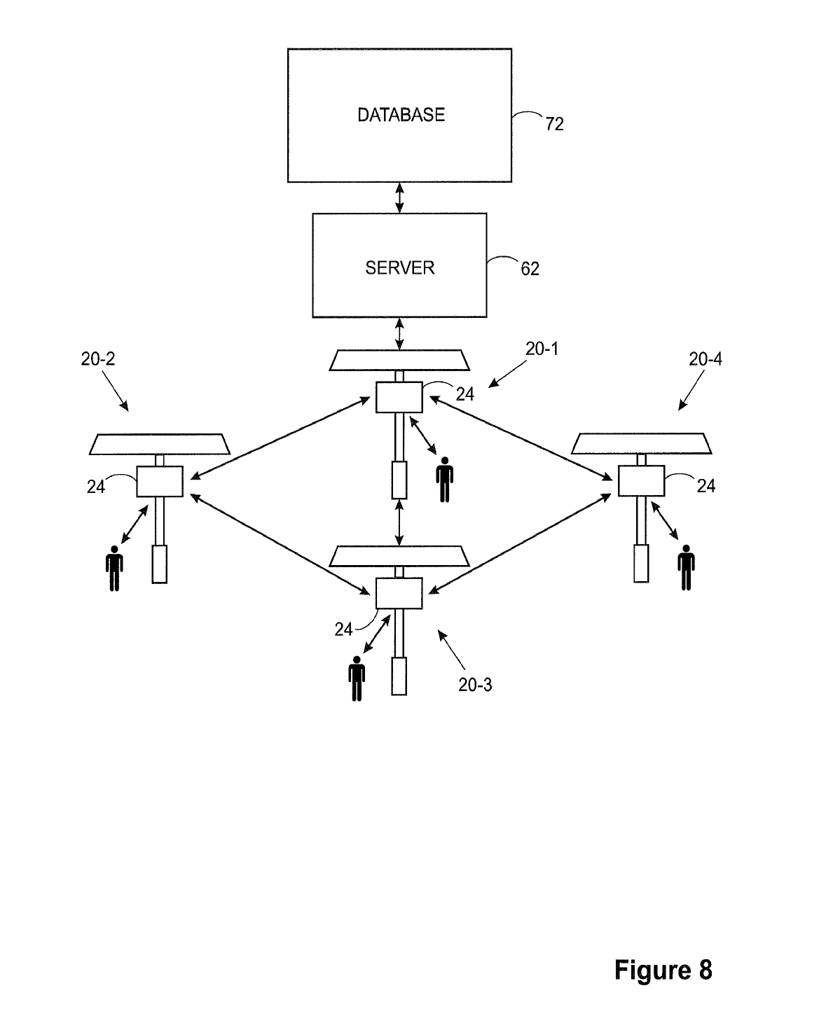

FIG. 8 is similar to FIG. 6 and illustrates one of the functions of the media trees 20. In particular, the media trees 20 can be used to generate invitations on the media panels 24 to invite people join the a Shoppers Network. Users will be able to scan a passive (QR code) or be directed by advertising on the media panel 24 to sign up for the Shoppers network by visiting the Shoppers Network website. Once signed up as a member, consumers will have access to coupons, which pertain to their favorite local stores or shopping centers. The consumer can access the special offers on line or on their mobile devices. The consumer can access the special offers on line or on their mobile devices, even if not on the location where the Media Trees, via the Shopper Networks website. Members can log on using their smart devices to the Shoppers Network while on location.

### Mall/Shopping Center with Special Localized Offers and Coupons

Further expansion of the “messaging” will be garnered through connection of existing Digital outdoor inventory, which will also allow to advertise an advertisers offer or marketing message as part of a Media Tree Media buy.

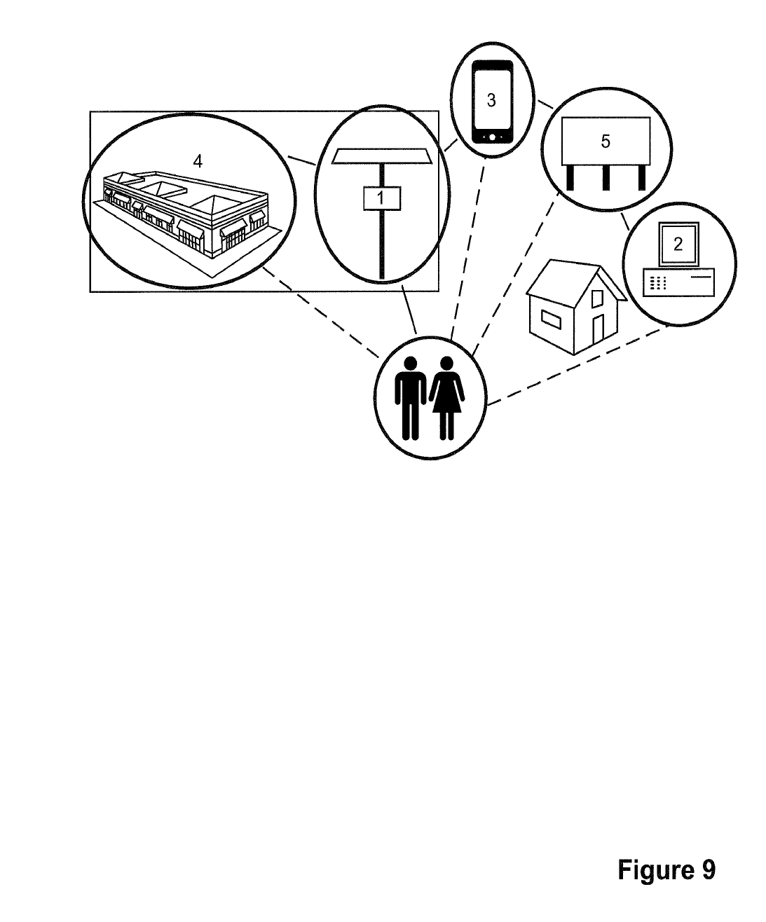

In accordance with one aspect of the invention, an advertiser will be able to advertise across multiple media platforms, for example, the media platforms 1-5 below and illustrated in FIG. 9.
1. Media Trees
2. Home computers (Shoppers Network Website)
3. Smart Device
4. Mall/shopping center with special localized offers and coupons
5. Further expansion of the “messaging” will be garnered through connection of existing

Digital outdoor inventory, which will also allow to advertise an advertisers offer or marketing message as part of a Media Tree Media buy.

### Process Flow

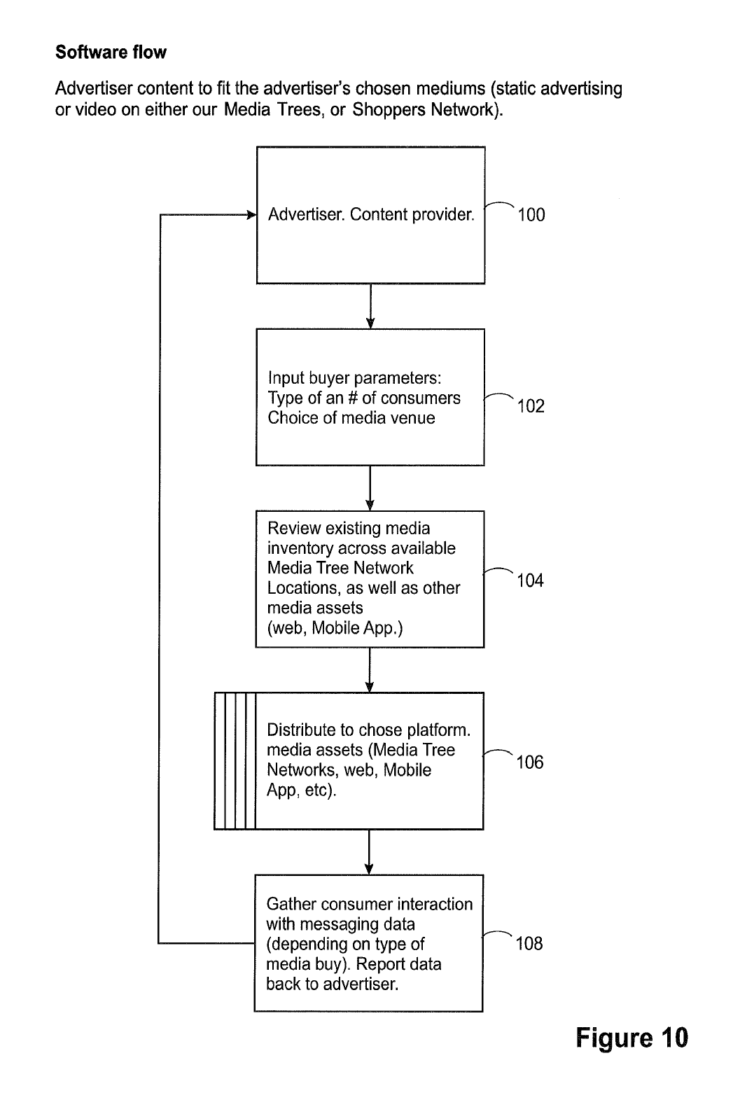

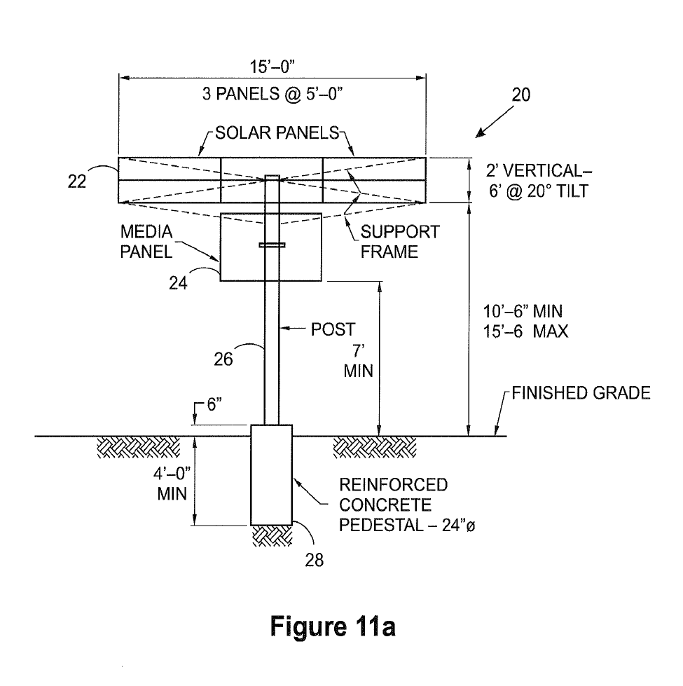

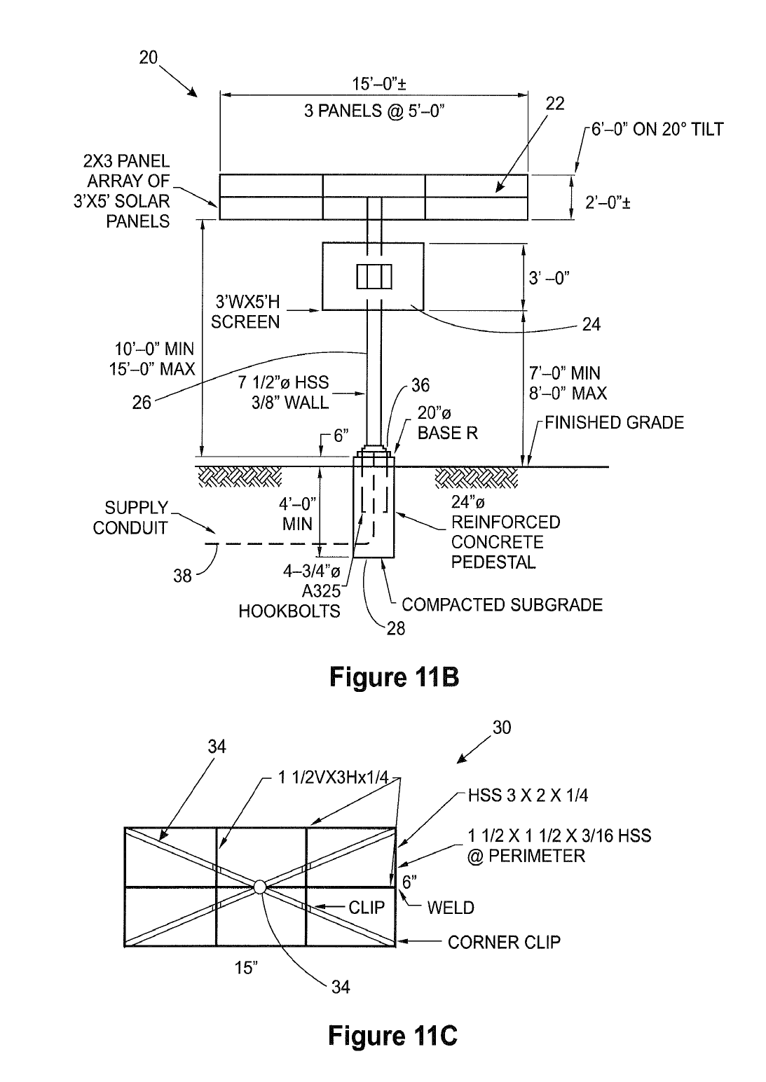

The process for setting up a marketing plan is illustrated in FIG. 10. In general advertiser content is configured to fit the advertiser's chosen mediums (static advertising or video on either our Media Trees, or Shoppers Network). Referring to FIG. 10, The advertiser's provides desired advertising content to be displayed in step 100. Next the advertisers identify the type of type and number of consumers and the choice of media venues in step 102. In step 104, the advertiser reviews existing media inventory across available media tree network, as well as other media assets, such as web, etc. Next in step 106, the digital content is distributed to the various platforms selected by the advertiser in step 106. In step 108, gather consumer interaction data, for example, number of requested coupons; web site hits, etc. This data is reported back to the advertiser in step 100.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

We claim:

1. A marketing method comprising the steps of:
(a) determining a locale for a consumer with a predetermined demographic; and
(b) locating a cluster of digital signs connected to a common network which display digital content directed to said consumer with said predetermined demographic.
